(19) United States
(12) Patent Application Publication
(10) Pub. No.: US 2026/0152366 A1
(43) Pub. Date: Jun. 4, 2026

(54) MULTI-SUPPORTED BEAM AS ELASTIC MEMBER FOR PROGRESSIVE SAFETIES

(71) Applicant: Otis Elevator Company, Farmington, CT (US)

(72) Inventor: Luis Marti, Coslada (ES)

(21) Appl. No.: 19/392,825

(22) Filed: Nov. 18, 2025

(30) Foreign Application Priority Data
Dec. 4, 2024 (EP) 24383322.5

(51) Int. Cl. B66B 5/22

(52) U.S. Cl. CPC B66B 5/22

(57) ABSTRACT

An elevator system includes an elevator car that is configured for traveling in a hoistway along a longitudinal direction (LD) between a plurality of landings; at least one guide rail for guiding the elevator car, the at least one guide rail includes a U-shaped profile formed by a first leg and a second leg extending from a base, the U-shaped profile defines an inner space of the U-shaped profile, and the first and second legs and the base have inner sides facing towards the inner space; at least one guide member attached to the elevator car, the at least one guide member contacts at least one guide surface of the at least one guide rail for guiding the elevator car along the guide rail; and at least one safety gear attached to the elevator car.

### FOREIGN PRIORITY

This application claims priority to European Patent Application No. 24383322.5, filed Dec. 4, 2024, and all the benefits accruing therefrom under 35 U.S.C. § 119, the contents of which in its entirety are herein incorporated by reference.

### TECHNICAL FIELD OF INVENTION

The invention relates to an elevator system, in particular to an elevator system comprising at least one guide rail for guiding the movement of an elevator car.

### BACKGROUND OF THE INVENTION

An elevator system typically comprises at least one elevator car that is configured for moving along a hoistway extending between a plurality of landings. Optionally, the elevator system may additionally comprise at least one counterweight that is configured for moving concurrently with the elevator car in the opposite direction.

The at least one elevator car and/or the at least one counterweight may be guided along the hoistway by at least one guide rail extending through the hoistway. The at least one elevator car and/or the at least one counterweight may be equipped with guide members, such as rollers, contacting a guide surface of the at least one guide rail and with at least one safety gear that is configured for frictionally engaging with the at least one guide rail in an emergency situation for braking any movement of the at least one elevator car/the at least one counterweight.

The at least one guide rail occupies some space in the hoistway resulting in an increase of the dimensions of the hoistway and/or in a decrease of the dimensions of the at least one elevator car. The engagement of the at least one safety gear with the guide rail after the at least one safety gear has been activated in an emergency situation or for testing may damage the guide surface of the at least one guide rail preventing a smooth ride of the guide member along the guide surface.

It would therefore be beneficial to provide an improved elevator system comprising at least one guide rail that allows for a more efficient spatial configuration of the elevator system and that prevents the at least one guide surface from being damaged by the at least one safety gear.

### SUMMARY OF THE INVENTION

An elevator system according to an exemplary embodiment of the invention comprises an elevator car that is configured for traveling in a hoistway along a longitudinal direction between a plurality of landings and at least one guide rail for guiding the elevator car. The at least one guide rail includes a U-shaped profile that is formed by a first leg and a second leg extending from a base. The first and second legs and the base define an inner space of the U-shaped profile. Each of the first and second legs and the base has an inner side facing towards the inner space. The space outside the inner space of the U-shaped profile is denoted as a space outside the U-shaped profile.

The elevator system further comprises at least one guide member attached to the elevator car and at least one safety gear attached to the elevator car. The at least one guide member contacts at least one guide surface of the at least one guide rail for guiding the elevator car along the least one guide rail. The at least one safety gear is configured for moving freely along the at least one guide rail when it is not activated, and for engaging with at least one engagement surface of the at least one guide rail for stopping any movement of the elevator car when the at least one safety gear is activated. The at least one guide surface of the at least one guide rail is not identical with, but different from, the at least one engagement surface of the at least one guide rail.

In an elevator system according to an exemplary embodiment of the invention including at least one guide rail having a U-shaped profile, the functionality of guiding the elevator car along the guide rail is assigned to at least one surface of the guide rail that differs from the at least one surface that is assigned to the functionality of providing an engaging surface for engaging with at least one safety gear for braking any movement of the elevator car are. Spatially separating these functionalities may allow for an improved spatial arrangement of the guide member(s) and the at least one safety gear attached to the elevator car. For example, in conventional elevator systems, the guide member(s) and the safety gear(s) are usually arranged on top of each other for interacting with the same surface of a guide rail. Such an arrangement limits the height of the guide member(s) and the safety gear(s). In an elevator system according to an exemplary embodiment of the invention, the guide member(s) and the safety gear(s) may be arranged next to each other for interacting with different portions of the guide rail. Such an arrangement may allow for an increased height of these components.

Since in an elevator system according to an exemplary embodiment of the invention the guide surface of the at least one guide rail that is configured for contacting the at least one guide member and the engagement surface that is configured for engaging with the at least one safety gear are spatially separated from each other, the guide surface is not damaged when the at least one safety gear is activated. In consequence, the ride quality of the at least one elevator car is not degraded and there is no need for smoothening the guide surface after the at least one safety gear has been activated.

In an elevator system according to an exemplary embodiment of the invention, a lubricant may be applied to the guide surface to smooth the ride of the elevator car, regardless of its potential adverse effects on the braking capabilities of the at least one safety gear.

A guide rail according to an exemplary embodiment of the invention may be produced easier and at lower costs than conventional guide rails having a T-shaped profile.

Since it comprises two legs, a guide rail according to an exemplary embodiment of the invention may offer greater stiffness and/or more compact outer dimensions than a conventional guide rail having a T-shaped profile comprising only a single leg.

The first and second legs of the U-shaped profile are arranged in a distance of 80 mm to 100 mm from each other. The first and second legs extend over a length of between 50 mm and 75 mm from the base. The base and the first and second legs may have a thickness in the range of 4 mm to 8 mm, in particular a thickness of 6 mm.

The u shaped profile may be formed by sheet-metal bending, by hot rolling, by cold drawing and/or by machining.

A guide rail having a u shaped profile formed by sheet-metal bending may be produced with fewer bending steps than a conventional guide rail having a T-shaped profile. A guide rail having a u shaped profile that is produced by hot rolling needs fewer section changes than a conventional guide rail having a T-shaped profile. In consequence, a guide rail having a u shaped profile may be produced at lower costs than a conventional T-shaped profile.

In an elevator system according to an exemplary embodiment of the invention, the at least one safety gear may be activated by at least one fixed trigger point that may be provided at or in the guide rail. In consequence, the at least one safety gear may substitute the buffers that are installed in the hoistways of conventional elevator systems for providing safe spaces at the bottom and/or at the top of the hoistway. Substituting the buffers may allow for a reduction of the costs of the elevator system.

With the same technique of at least one fixed trigger point that is provided at or in the guide rail, the at least one safety gear may be pre-triggered as an additional safety measure in case the overspeed governor of the elevator system is not yet operational, for example during the erection phase of the elevator system.

In the following, a number of further optional features of an elevator system according to exemplary embodiments of the invention are set out. These features may be realized in particular embodiments, alone or in combination with any of the other features, unless explicitly stated otherwise.

The first leg and the second leg of the U-shaped profile may extend basically parallel to each other, particularly basically perpendicularly from the base. Such a rectangular structure is easy to produce and offers high rigidity and stability.

The at least one guide surface of the at least one guide rail may include an outer surface and/or a front surface of at least one of the legs, and the at least one guide member may be arranged at least partially on an outer side of the u shaped profile of the guide rail for contacting the outer surface and/or the front surface, respectively. The outer sides of the first and second legs and the base are the sides that are opposite to the inner sides of the first and second legs and the base facing the inner space of the U-shaped profile.

The at least one safety gear may be arranged at least partially in the inner space of the u shaped profile, and the at least one engagement surface may include an inner surface of the U-shaped profile, in particular an inner surface of one of the legs and/or an inner surface of the base.

Arranging the at least one guide member at least partially on an outer side of the u shaped profile and arranging the at least one safety gear at least partially in the inner space of the u shaped profile allows for a spatial separation of the at least one guide member and the at least one safety gear.

Exemplary embodiments of the invention may further include a safety gear that is configured for being arranged between the first and second legs of a guide rail having a U-shaped profile. The safety gear comprises a first engagement member provided on a first side of the safety gear and configured for engaging with a first engagement surface provided on the first leg of the u shaped profile when the safety gear is activated. A second engagement member, such as roller, is provided on an opposite second side of the safety gear and it is configured for engaging with a second engagement surface provided on the second leg of the U-shaped profile when the safety gear is activated. The safety gear further comprises at least one elastic element that is configured for elastically urging the second engagement member against the second engagement surface when the safety gear is activated.

Exemplary embodiments of the invention may also include an elevator system comprising at least one guide rail having a U-shaped profile and at least one safety gear that is arranged between the first and second legs of the at least guide rail having a U-shaped profile. The safety gear comprises a first engagement member provided on a first side of the safety gear and configured for engaging with a first engagement surface when the safety gear is activated. The first engagement surface is provided on the first leg of the u shaped profile, and a second engagement surface is provided on the second leg of the U-shaped profile. A second engagement member, such as a roller, is provided on an opposite second side of the safety gear and is configured for engaging with the second engagement surface when the safety gear is activated. The safety gear further comprises at least one elastic element that is configured for elastically urging the second engagement member against the second engagement surface when the safety gear is activated.

When the at least one safety gear is arranged in the U-shaped profile, it may be designed more simple, at lower costs and more compact, with no limitations in the vertical dimension.

When the vertical dimension of the at least one safety gear along the guide rail is increased, the area of contact between the at least one engagement member of the at least one safety gear and the guide rail may be increased as well. In consequence, the at least one engagement member may be made from a less expensive material.

When the guide rail does not extend though the at least one safety gear, its size and structural strength may be improved significantly.

The at least one guide member may be configured for moving along the first leg of the u shaped profile; and the at least one safety gear may be configured for engaging with the second leg of the U-shaped profile. In other words, the at least one guide surface may be formed on the first leg, and the at least one engagement surface may be formed on the second leg. Such a configuration results in an efficient spatial separation between the at least one guide surface and the at least one at least one engagement surface.

The at least one guide member may include a U-shaped profile encompassing the first leg. The U-shaped profile of the guide member may in particular form a guide shoe that is configured for encompassing and moving along the first leg of the guide rail. Such a guide shoe may provide an efficient guide member that does not comprise any rotating elements.

Engagement surfaces may be formed on an inner surface and on an outer surface of the second leg. The at least one safety gear may be configured for engaging with the inner surface and with the outer surface of the second leg. Providing two engagement surfaces on the second leg may enhance the braking capabilities of the at least one safety gear.

In another embodiment, the at least one guide member may be configured for moving inside the U-shaped profile and the at least one safety gear may be configured for engaging with at least one outer surface of the U-shaped profile.

The at least one guide member may include at least one roller that is configured for rolling along the at least one guide surface. Providing the at least one guide member with at least one roller may reduce the friction between the at least one guide member and the at least one guide surface.

The surface properties of the at least one guide surface and of the at least one engagement surface may be identical. A guide rail in which the surface properties of the at least one guide surface and of the at least one engagement surface are identical is easy to produce at low costs.

Alternatively, the at least one guide surface and the at least one engagement surface may have different surface properties. The at least one engagement surface may in particular have a larger surface roughness than the at least one guide surface in order to enhance the braking capabilities of the at least one safety gear by increasing the friction between the at least one engagement surface and the engagement member(s).

An elevator system according to an exemplary embodiment of the invention may further comprise a counterweight that is configured for moving concurrently with the elevator car in an opposite direction. The elevator system may comprise at least one counterweight guide rail for guiding the counterweight, wherein the at least one counterweight guide rail includes a U-shaped profile having a first leg and a second leg extending from a base. The elevator system may further comprise at least one counterweight guide member attached to the counterweight, wherein the at least one guide rail contacts at least one guide surface of the at least one counterweight guide rail for guiding the counterweight along the counterweight guide rail; and at least one counter¬weight safety gear that is attached to the counterweight. The at least one counter¬weight safety gear may be configured for moving along the counterweight guide rail and for engaging with at least one engagement surface of the at least one counterweight guide rail in order to stop movement of the counterweight, when the at least one counterweight safety gear is activated. The at least one guide surface of the at least one counterweight guide rail may be different from the at least one engagement surface of the at least one counterweight guide rail.

The advantages of a guide rail having a U-shape profile that have been discussed before with respect to a guide rail for guiding an elevator car correspondingly apply to a counterweight guide rail having a U-shaped profile.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIGS. 2A to 2D depict schematic cross-sectional views of guide rails according to exemplary embodiments of the invention.

FIG. 3 depicts a cross-sectional view of a guide rail according to an exemplary embodiment of the invention that is mounted to a support.

FIG. 4A depicts a schematic sectional view of an elevator car that is guided by two guide rails according to an exemplary embodiment of the invention.

FIG. 4B depicts an enlarged view of two guide rollers and one of the two guide rails depicted in FIG. 4A.

FIG. 5A depicts a schematic sectional view of an elevator car in a hoistway that is guided by two guide rails according to another exemplary embodiment of the invention.

FIG. 5B depicts an enlarged view of two guide rollers and one of the two guide rails depicted in FIG. 5A.

FIG. 6 depicts a sectional view through a safety gear that may be arranged in a guide rail according to an exemplary embodiment of the invention.

FIG. 7 depicts a guiding structure for guiding an elevator car along a guide rail according to a further exemplary embodiment of the invention.

FIG. 8 depicts a sectional view through a safety gear that may be employed in the guiding structure depicted in FIG. 7.

### DETAILED DESCRIPTION OF THE INVENTION

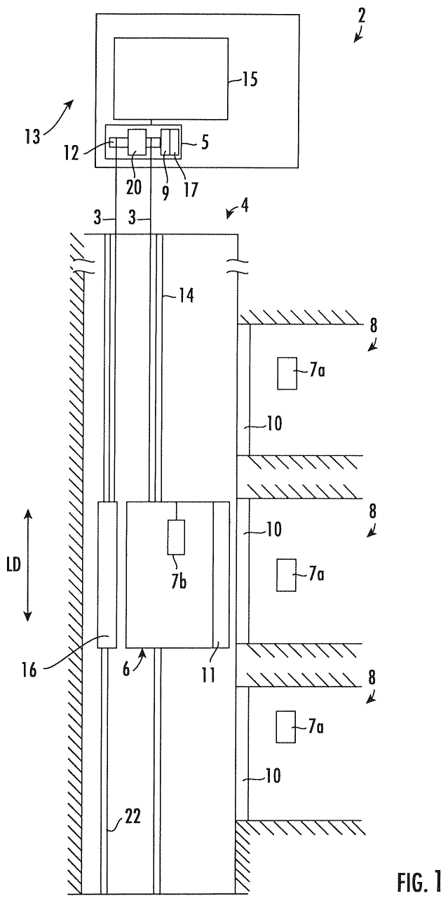

FIG. 1 schematically depicts an elevator system 2 according to an exemplary embodiment of the invention.

The elevator system 2 comprises a hoistway 4 extending in a longitudinal direction LD between a plurality of landings 8 located on different floors. The elevator system 2 includes an elevator car 6 that is arranged in the hoistway 4 for being moved along the longitudinal direction LD between the plurality of landings 8. The elevator car 6 may in particular be movable along at least one elevator car guide rail 14, provided in the hoistway 4 and extending along the longitudinal direction LD.

The longitudinal direction LD may be oriented in a vertical direction, as it is depicted in FIG. 1. In an alternative embodiment that is not depicted in the figures, the longitudinal direction LD may be inclined with respect to the vertical direction.

Although only a single elevator car guide rail 14 is depicted in FIG. 1, the elevator system 2 may comprise a plurality of elevator car guide rails 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the at least one tension member 3, which is coupled to the shaft 12 via traction, in order to move the elevator car 6 in the hoistway 4 along the longitudinal direction LD between the plurality of landings 8.

The elevator drive system 5 is further provided with at least one elevator brake 20 for braking rotation of the shaft 12 in order to allow for stopping movement of the elevator car 6 and holding the elevator car 6 at a desired position in the hoistway 4.

Optionally, the elevator system 2 may comprise a counterweight 16. The counterweight 16 may be attached to the at least one tension member 3 opposite to the elevator car 6 and configured for moving concurrently and in opposite direction with respect to the elevator car 6. The counterweight may move along at least one counterweight guide rail 22, such as at least one counterweight guide rail, provided in the hoistway 4 and extending along the longitudinal direction LD.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment shown in FIG. 1, a 1:1 roping is employed for suspending the elevator car 6. The type of the roping is, however, not essential for the invention and different kinds of roping, e.g. a 2:1 roping or a 4:1 roping may be employed as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

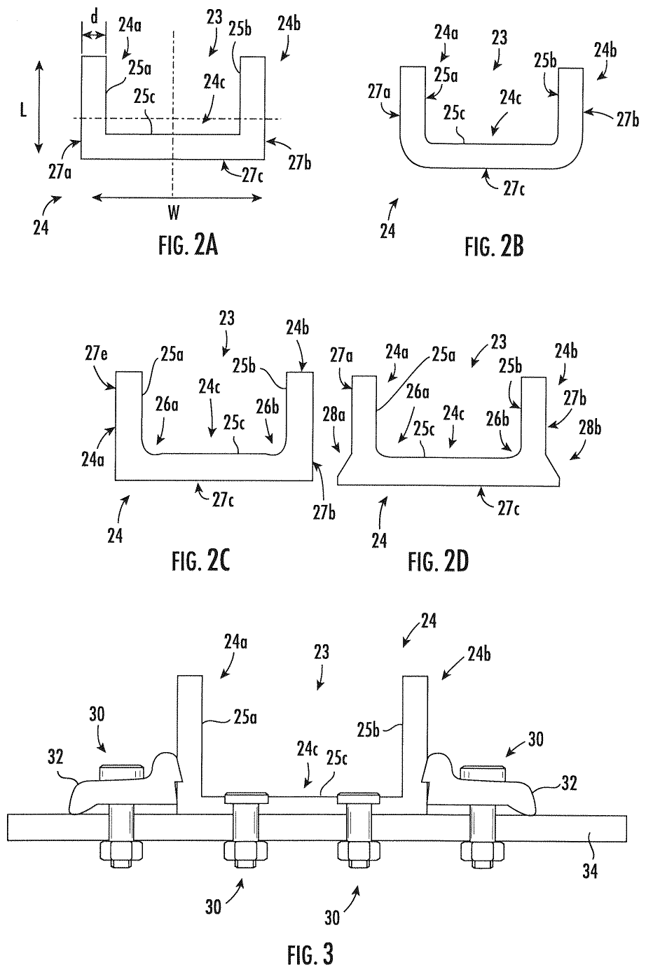

FIG. 2A depicts a schematic cross-sectional view of a guide rail 24 having a u shaped profile according to an exemplary embodiment of the invention.

A guide rail 24 according to an exemplary embodiment of the invention may be employed as an elevator car guide rail 14 and/or as a counterweight guide rail 22 as depicted in FIG. 1.

A guide rail 24 having a u shaped profile according to an exemplary embodiment of the invention comprises a first leg 24a and a second leg 24b extending parallel to each other from a base 24c. The first and second legs 24a, 24b may in particular be oriented perpendicularly to the base 24c, as it is depicted in FIG. 2A.

The first and second legs 24a, 24b may have a length L in the range of 80 mm to 100 mm, in particular a length L in the range of 85 mm to 90 mm.

The base 24c may have a width W of in the range of 50 mm to 75 mm, in particular a width W of in the range of 55 mm to 60 mm.

The first and second legs 24a, 24b and the base 24c may have a thickness d in the range of 4 mm to 8 mm, in particular a thickness of 6 mm.

The first and second legs 24a, 24b and the base 24c define an inner space 23 of the U-shaped profile 24. Each of the first and second legs 24a, 24b and the base 24c has an inner side 25a-25c facing towards the inner space 23, and an outer side 27a-27c facing away from the inner space 23.

The guide rail 24 may be formed by bending a sheet of metal. This may result in a rounded transition between the base 24c and each of the first and second legs 24a, 24b, as it is depicted in FIG. 2B.

In an alternative embodiment, a guide rail 24 according to an exemplary embodiment of the invention may be manufactured by hot rolling.

Schematic cross-sectional views of guide rails 24 according to exemplary embodiments of the invention that are made by hot rolling are depicted in FIGS. 2C and 2D.

As depicted in FIGS. 2C and 2D, rounded undercuttings 26a, 26b may be formed at the transitions between the base 24c and each of the legs 24a, 24b, respectively. Providing such rounded undercuttings 26a, 26b may reduce the mechanical stresses in said areas. Reducing the mechanical stresses may result in less wear and a longer lifetime of the guide rail 24.

Alternatively or additionally, bulges 28a, 28b may be formed at the outer edges of the base 24c, as exemplarily depicted in FIG. 2D, for increasing the rigidity and the strength of the guide rail 24 even further.

In the exemplary embodiment depicted in FIG. 2D, each of the bulges 28a, 28b has a triangular cross-section. In further embodiments that are not explicitly depicted in the figures, other shapes of the bulges 28a, 28b are possible as well.

FIG. 3 depicts a cross-sectional view of a guide rail 24 according to an exemplary embodiment of the invention that is mounted to a support 34. The support 34 may be provided at a wall of a hoistway 4 of the elevator system 2.

The guide rail 24 may be mounted to the support 34 using fixing elements 30, such as bolts, rivets or screws, that extend through the base 24c of the guide rail 24.

Alternatively or additionally, brackets 32 may be used for fixing the guide rail 24 to the support 34. Fixing elements 30 may be employed for fixing the brackets 32 to the support 34.

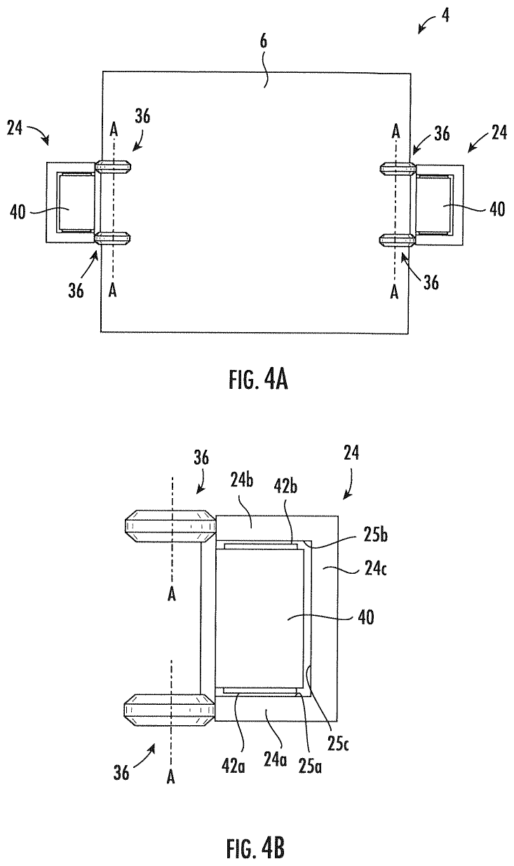

FIG. 4A depicts a schematic sectional view of an elevator car 6 in a hoistway 4 that is guided by two guide rails 24 according to exemplary embodiments of the invention. In the illustration depicted in FIG. 4A, the sectional plane is oriented perpendicularly to the longitudinal direction LD; i.e. the elevator car 6 is moving perpendicularly to the plane of view of FIG. 4A.

The elevator car 6 depicted in FIG. 4A comprises four guide members 26, in particular four guide rollers 36, that are configured for guiding the elevator car 6 along the guide rails 24. Two guide rollers 36 are provided on each lateral side of the elevator car 6, respectively. Each guide roller 36 contacts a guide rail 24 having a U-shape profile that is provided next to the respective side of the elevator car 6.

FIG. 4B depicts an enlarged view of the guide rollers 36 and the guide rail 24 provided on the right side of the elevator car 6. The elevator car 6 is not depicted in FIG. 4B.

In the embodiment depicted in FIGS. 4A and 4B, the end faces of the first and second legs 24a, 24b facing the elevator car 6 provide guide surfaces and the guide rollers 36 are configured for contacting and rolling along said end faces of the first and second legs 24a, 24b.

The elevator car 6 further comprises two safety gears 40 that are provided at the lateral sides of the elevator car 6. The safety gears 40 are configured for moving along the guide rails 24 concurrently with the elevator car 6 without engaging with the guide rails 24 during normal operation. The safety gears 40 are further configured for engaging with the guide rails 24 in an emergency situation for braking and/or for preventing any movement of the elevator car 6 along the guide rails 24.

In the exemplary embodiment depicted in FIGS. 4A and 4B, each of the safety gears 40 is arranged in the inner space 23 of one of the guide rails 24, respectively, resulting in a space saving configuration of the elevator system 2.

Each of the safety gears 40 comprises two engagement members 42a, 42b that are configured for frictionally engaging with the inner sides 25a, 25b of the first and second legs 24a, 24b of the respective guide rail 24 for stopping any movement of the elevator car 6 when the respective safety gear 40 is activated.

The inner sides 25a, 25b of the first and second legs 24a, 24b are engagement surfaces of the respective guide rail 24 that are configured for engaging with the corresponding engagement members 42a, 42b of the respective safety gear 40 when the safety gears 40 are activated.

In the exemplary embodiment depicted in FIGS. 4A and 4B, the guide rollers 36 are rotatable around axes A that are oriented parallel to the respective lateral sides of the elevator car 6.

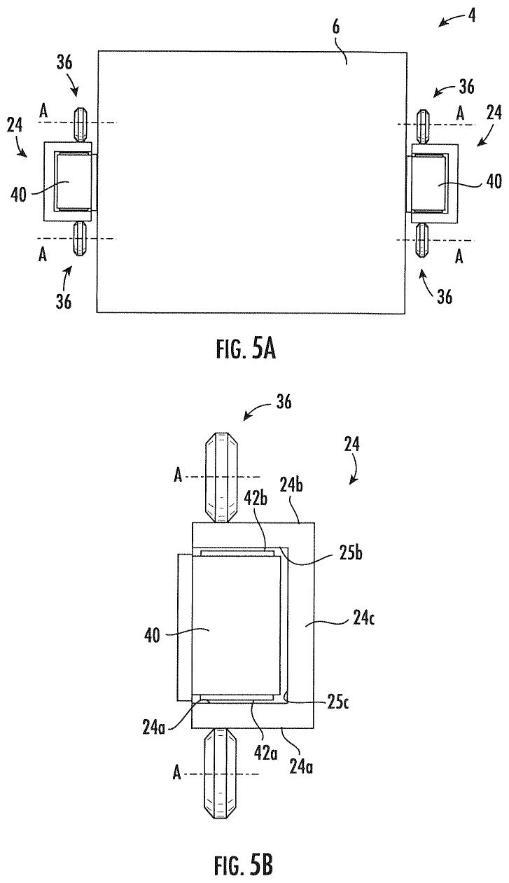

FIGS. 5A and 5B depict an alternative embodiment, in which the axes A of the guide rollers 36 are oriented perpendicularly to the respective lateral sides of the elevator car 6.

FIG. 5A depicts a schematic sectional view of an elevator car 6 in a hoistway 4 that is guided by two guide rails 24 according to exemplary embodiments of the invention. FIG. 5B depicts an enlarged view of the guide rollers 36 and the guide rail 24 provided on the right side of the elevator car 6. The elevator car 6 is not depicted in FIG. 5B.

In the embodiment depicted in FIGS. 5A and 5B, the guide rollers 36 do not contact the end faces of the first and second legs 24a, 24b facing the elevator car 6.

Instead, the guide rollers 36 are configured for contacting and rolling along the outer sides 27a, 27b of the first and second legs 24a, 24b, i.e. the side of the first and second legs 24a, 24b facing away from the inner space 23 formed by the

first and second legs 24a, 24b and the base 24c.

In consequence, the outer sides 27a, 27b of the first and second legs 24a, 24b from the guide surfaces for guiding the guide rollers 36 along the guide rails 24.

The elevator car 6 further comprises two safety gears 40 provided at the lateral sides of the elevator car 6. Similar to the embodiment depicted in FIGS. 4A and 4B, the safety gears 40 are arranged in an inner space 23 of the respective guide rail 24. The previous description of the safety gears 40 referring to FIGS. 4A and 4B correspondingly applies to the safety gears 40 of the embodiment depicted in FIGS. 5A and 5B.

In an elevator system 2 according to an exemplary embodiment of the invention as it is depicted in FIGS. 4A to 5B, the guide surfaces contacting the guide rollers 36 of the guide rails 24 are spatially separated from the engagement surfaces that are configured for engaging with the engagement members 42a, 42b of the safety gears 40.

As a result, the guide surfaces for the guide rollers 36 remain unaffected when the safety gears 40 are activated. This may reduce the need for repair and/or maintenance of the guide rails 24, in particular after the safety gears 40 have been activated. It may further enhance the riding comfort for passengers within the elevator car 6.

For reducing wear and for allowing for a smooth ride of the elevator car, small friction is desirable between the guide rollers 36 and the corresponding guide surface. In contrast, in order allow for a fast and efficient braking of the elevator car 6 when the safety gears 40 are activated, large friction is desirable between the engagement members 42a, 42b of the safety gears 40 and the corresponding engagement surfaces of the guide rails 24.

Spatially separating the guide surfaces from the engagement surfaces further allows for providing the guide surfaces and the engagement surfaces with different surfaces properties. The engagement surfaces may in particular have a larger surface roughness than the guide surfaces.

Spatially separating the guide surfaces and the engagement surfaces from each other further allows for applying a lubricant to the guide surfaces without negatively affecting the braking properties of the engagement surfaces.

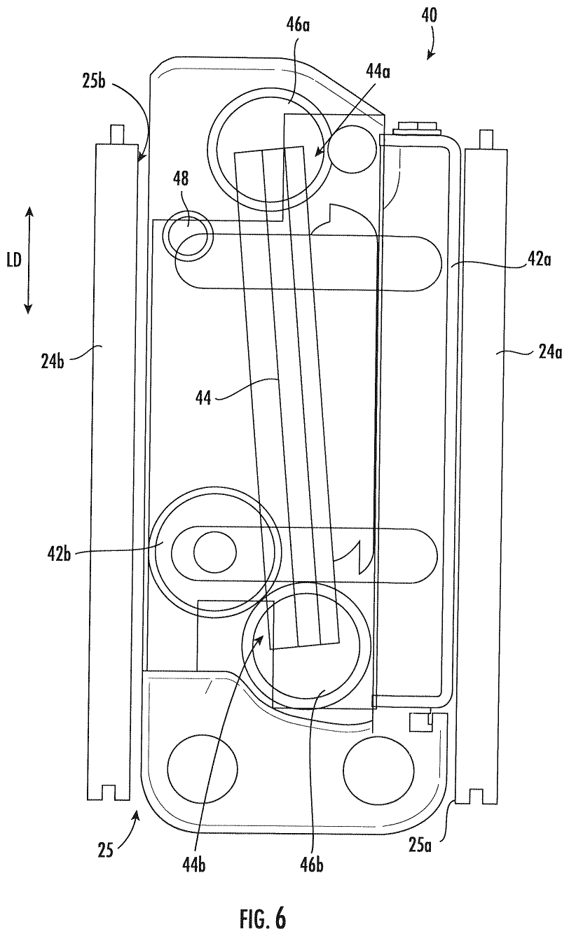

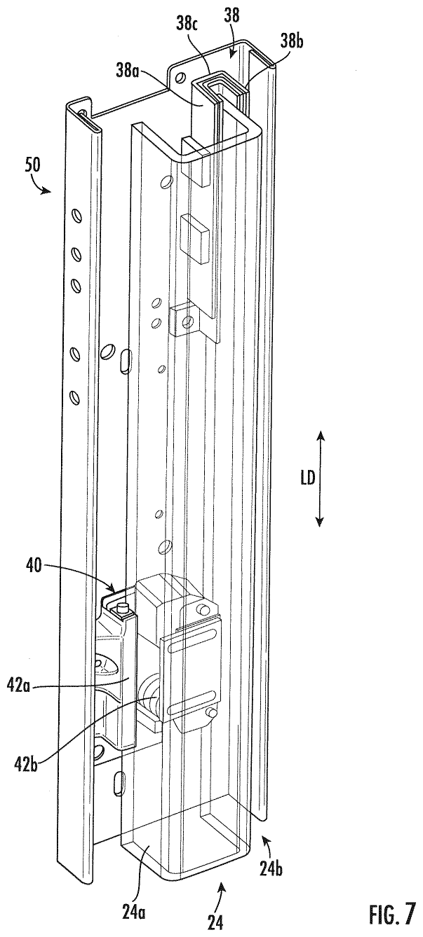

FIG. 6 depicts a sectional view through a safety gear 40 that may be arranged in the inner space 23 of a guide rail 24 having a U-shaped profile according to an exemplary embodiment of the invention, as depicted in FIGS. 4A to 5B.

The safety gear 40 depicted in FIG. 6 comprises a first engagement member 42a, in particular a brake shoe, and a second engagement member 42b that is in particular provided in the form of a roller.

The first and second engagement members 42a, 42b are arranged on opposite sides of the safety gear 40. The first engagement member 42a is in particular provided on the side of the safety gear 40 facing the first leg 24a of the guide rail 24, and the second engagement member 42b is provided on the opposite side of the safety gear 40 facing the second leg 24b of the guide rail 24.

The safety gear 40 further comprises an elastic element 44 that is arranged between the first and second engagement members 42a, 42b. The elastic element 44 has a first end 44a and a second end 44b and extends between two spring fixtures 46a, 46b.

The elastic element 44 may comprise at least one leaf spring. Optionally, the elastic element 44 may comprise a plurality of leaf springs extending parallel to each other. The elastic element 44 may in particular comprise a plurality of leaf springs that are arranged in a sandwich structure on top of each other forming a stack of lead springs. The thickness of the elastic element 44 depends on its length and on the load the safety gear 40 is designed for.

The elastic element 44 extends at an angle with respect to the first and second legs 24a, 24b of the guide member 24 so that the first end 44a is closer to the second leg 24b than the second end 44b defining a tapered region between the second leg 24b and the elastic element 44. The elastic element 44 may, for example, be arranged at an angle in the range of between 3° and 15° with respect to the second leg 24b.

The second engagement member 42b that is provided as a roller is movably arranged within the tapered region defined by the elastic element 44 and the second leg 42b.

When the safety gear 40 is in a standby configuration, as it is depicted in FIG. 6, in which the safety gear 40 is not activated, the second engagement member 42b is located in a standby position, in which it does not contact the second leg 24b of the guide rail 24. The standby position of the second engagement member 42b may, in particular, be in the vicinity to the second end 44b of the elastic element 44, as it is illustrated by the second engagement member 42b depicted in FIG. 6.

When the safety gear 40 is in the standby configuration, the safety gear 40 and, in consequence, an elevator car 6 or an elevator counterweight 16, to which the safety gear 40 is attached, are capable to move freely along the guide rail 24.

For activating the safety gear 40, the second engagement member 42b is moved towards the second leg 24b by an activation mechanism that is not depicted in FIG. 6.

The second engagement member 42b contacting the second leg 24b results in frictional engagement between the second engagement member 42b and the second leg 24b. As a result of said frictional engagement, a downward movement of the safety gear 40 with respect to the second leg 24b causes the second engagement member 42b to roll along the second leg 24b on one side (the left side of the second engagement member 42b in FIG. 6) and to roll upwards along the elastic element 44 on the other side (the right side of the second engagement member 42b in FIG. 6).

The safety gear 40 may further comprise a stopper 48 that is located in the vicinity of the second end 44b of the elastic element 44 and that is configured for preventing the second engagement member 42b from moving beyond the second end 44b of the elastic element 44.

Due to the inclined orientation of the elastic element 44 with respect to the second leg 24b, this movement of the second engagement member 42b causes the second engagement member 42b to move into a wedged condition, in which the second engagement member 42b is sandwiched between the second leg 24b and the elastic element 44.

In said wedged condition, the elastic element 44 presses the second engagement member 42b against the second leg 24b, generating a braking force between the second leg 24b and the roller 42. Further, the first engagement member 42a is pressed against the first leg 24a of the guide rail 24, generating a braking force between the second leg 24a and first engagement member 42a. Said braking forces brake the movement of the safety gear 40 with respect to the first and second legs 24a, 24b of the guide rail 24 until said movement is stopped.

Arranging the safety gear 40 in the inner space 23 of one of the guide rails 24, as it is depicted in FIG. 6, allows for a space saving configuration of the elevator system 2.

FIG. 7 depicts a guiding structure for guiding an elevator car 6 along a guide rail 24 according to another exemplary embodiment of the invention.

In order to enhance the clarity of the illustration, only a beam, in particular an upright 50, of the elevator car 6 is depicted in FIG. 7.

A U-shaped guide member 38 and a safety gear 40 are mounted to the upright 50 of the elevator car 6 for moving concurrently with the elevator car 6 in the longitudinal direction LD along the guide rail 24.

The U-shaped guide member 38 comprises a first leg 38a and a second leg 38b extending parallel to each other from a base 38c. The first and second legs 38a, 38b may in particular be oriented perpendicularly to the base 38c.

The U-shaped guide member 38 may, for example, be made by bending a sheet of metal.

The U-shaped profile defines an inner space of the U-shaped guide member 38.

An outer end portion of the second leg 24b of the guide rail 24 is accommodated in the inner space of the U-shaped guide member 38. In consequence, the U-shaped guide member 38 is guided along the second leg 24b of the guide rail 24.

In the embodiment depicted in FIG. 7, the safety gear 40 is arranged at the first leg 24a partially inside and partially outside of the guide rail 24 with the first leg 24a of the guide rail 24 extending through the safety gear 40 along the longitudinal direction LD.

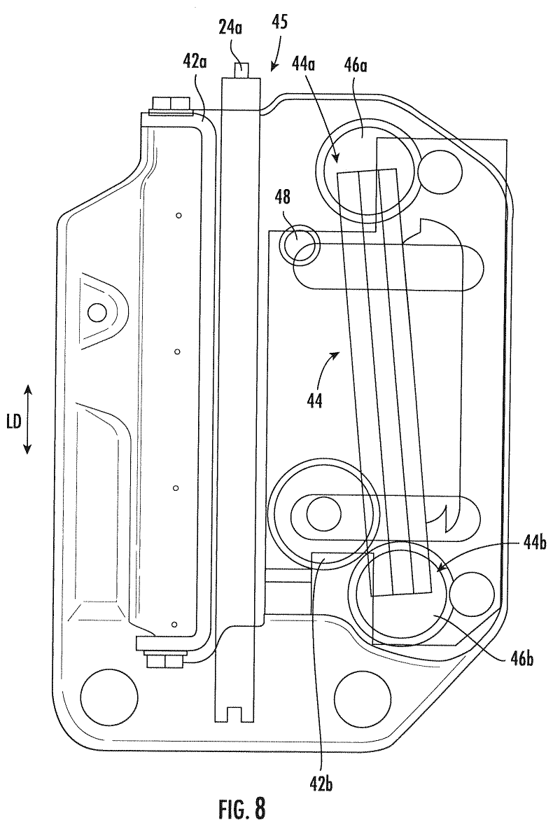

FIG. 8 depicts a sectional view through a safety gear 40 that may be employed in combination with a guide rail 24 in a configuration as it is depicted in FIG. 7.

In the embodiment depicted in FIGS. 7 and 8, the safety gear 40 comprises a passage 45 extending through the safety gear 40. The passage 45 is configured for accommodating a portion of the first leg 24a of the guide rail 24 extending through the safety gear 40 along the longitudinal direction LD.

A first engagement member 42a, in particular a brake shoe, is arranged on a first side of the passage 45 and a second engagement member 42b, in particular a roller, is arranged on an opposite second side of the passage 45.

Similar to the embodiment depicted in FIG. 6, the safety gear 40 comprises an inclined elastic element 44 that is configured for elastically urging the second engagement member 42b against the first leg 24a of the guide rail 24, when the safety gear 40 is activated, as it has been described before with respect to the exemplary embodiment of a safety gear 40 depicted in FIG. 6.

The second engagement member 42b is movably arranged within the tapered region defined by the first leg 24a and the elastic element 44.

When the safety gear 40 is in a standby configuration, as it is depicted in FIG. 8, in which the safety gear 40 is not activated, the second engagement member 42b is located in a standby position, in which it does not contact the first leg 24a. The standby position of the second engagement member 42b may, in particular, be in the vicinity to the second end 44b of the elastic element 44, as it is illustrated in FIG. 8.

In the standby configuration, the safety gear 40 and, in consequence, the elevator car 6 to which the safety gear 40 is mounted, are capable to move freely in the longitudinal direction LD along the first leg 24a of the guide rail 24.

For activating the safety gear 40, the second engagement member 42b is moved towards the first leg 24a by an activation mechanism, which is not depicted in the figures.

The second engagement member 42b contacting the first leg 24a results in frictional engagement between the second engagement member 42b and the first leg 24a. As a result of said frictional engagement, a downward movement of the safety gear 40 with respect to the first leg 24a causes the second engagement member 42b to roll along the first leg 24a on one side (the left side of the second engagement member 42b in FIG. 8) and to roll upwards along the elastic element 44 on the other side (the right side of the second engagement member 42b in FIG. 8).

Due to the inclined orientation of the elastic element 44 with respect to the first leg 24a, this movement of the second engagement member 42b causes the second engagement member 42b to move into a wedged condition, in which the second engagement member 42b is sandwiched between the first leg 24a and the elastic element 44.

In said wedged condition, the second engagement member 42b presses against the first leg 24a, generating braking forces between the first leg 24a and the first and second engagement members 42a, 42b of the safety gear 40. Said braking forces brake the movement of the safety gear 40 with respect to the first leg 24a, until said movement has been stopped.

Since in the embodiment depicted in FIG. 7, the second engagement member 42b of the safety gear 40 engages with the first leg 24a of the guide rail 24 and the U-shaped guide member 38 moves along the second leg 24b, the engagement surfaces provided at the first leg 24a are separated from the guide surfaces provided at the second leg 24b.

In consequence, the embodiment depicted in FIG. 7 also provides the advantages of separating the guide surfaces from the engagement surfaces of the guide rail 24 that have been described before with reference to FIGS. 4A to 5B.

In the embodiment depicted in FIGS. 7 and 8, the safety gear 40 is arranged at the first leg 24a and the U-shaped guide member 38 is arranged at the second leg 24b of the guide rail 24.

In an alternative embodiment, that is not explicitly depicted in the figures, the safety gear 40 may be arranged at the second leg 24b and the U-shaped guide member 38 is arranged at the first leg 24a of the guide rail 24.

Exemplary embodiments of an elevator system 2 according to the invention have been described with reference to an elevator car 6. FIGS. 2A to 8 and the corresponding description correspondingly apply to elevator systems 2 comprising at least one counterweight 16 that is guided along the hoistway 4 by guide rails 24 having a U-shaped profile that are employed as counterweight guide rails 22.

The safety gears 40 depicted in FIGS. 6 and 8 are configured for braking a downward movement of the respective safety gear 40 with respect to the guide rail 24.

Additionally or alternatively, an elevator system 2 according to an exemplary embodiment of the invention may also comprises at least one safety gear 40 that is configured for braking an upward movement of the elevator car 6 or of the counterweight 16.

A safety gear 40 that is configured for braking an upward movement is oriented in an upside-down orientation with respect to the orientations of the safety gears 40 depicted in FIGS. 6 and 8. In such an upside-down orientation, the first end 44a of the elastic element 44 that is arranged closer to the second leg 24b than the opposite second end 44b is arranged below the second end 44b.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the claims.

What is claimed is:

1. Elevator system (2) comprising:
an elevator car (6) that is configured for traveling in a hoistway (4) along a longitudinal direction (LD) between a plurality of landings (8);
at least one guide rail (14; 24) for guiding the elevator car (6), wherein the at least one guide rail (14; 24) includes a U-shaped profile formed by a first leg (24a) and a second leg (24b) extending from a base (24c), wherein the U-shaped profile defines an inner space (23) of the U-shaped profile, and the first and second legs (24a, 24b) and the base (24c) have inner sides (25a-25c) facing towards the inner space (23);
at least one guide member (36, 38) attached to the elevator car (6), wherein the at least one guide member (36, 38) contacts at least one guide surface of the at least one guide rail (14; 24) for guiding the elevator car (6) along the at least one guide rail (14; 24); and
at least one safety gear (40) attached to the elevator car (6), wherein the at least one safety gear (40) is configured for moving along the at least one guide rail (14; 24) and for engaging with at least one engagement surface of the at least one guide rail (14; 24) in order to stop movement of the elevator car (6), when the at least one safety gear (40) is activated;
wherein the at least one guide surface of the at least one guide rail (14; 24) is different from the at least one engagement surface of the at least one guide rail (14; 24).

2. Elevator system (2) comprising:
an elevator car (6) that is configured for traveling in a hoistway (4) along a longitudinal direction (LD) between a plurality of landings (8);
a counterweight (16) that is configured for moving concurrently with the elevator car (6) in an opposite direction;
at least one guide rail (22; 24) for guiding the counterweight (16), wherein the at least one guide rail (22; 24) includes a U-shaped profile having a first leg (24a) and a second leg (24b) extending from a base (24c);
at least one guide member (36, 38) attached to the counterweight (16), wherein the at least one guide member (36, 38) contacts at least one guide surface of the at least one guide rail (22; 24) for guiding the counterweight (16) along the guide rail (22; 24);
at least one safety gear (40) attached to the counterweight (16), wherein the at least one safety gear (40) is configured for moving along the guide rail (22; 24) and for engaging with at least one engagement surface of the at least one guide rail (22; 24) in order to stop movement of the counterweight (16), when the at least one safety gear (40) is activated;
wherein the at least one guide surface of the at least one guide rail (22; 24) is different from the at least one engagement surface of the at least one guide rail (22; 24);
wherein the elevator system (2) is an elevator system (2) according to claim 1.

3. Elevator system (2) according to claim 1, wherein the first leg (24a) and the second leg (24b) extend basically parallel to each other, particularly basically perpendicularly from the base (24c).

4. Elevator system (2) according to claim 1, wherein the at least one guide member (36, 38) is at least partially arranged on an outer side of the U-shaped profile of the guide rail (24) and wherein the at least one guide surface of the at least one guide rail (24) includes an outer surface or a front surface of at least one of the first and second legs (24a, 24b).

5. Elevator system (2) according to claim 1, wherein the at least one safety gear (40) is at least partially arranged in the inner space (23) of the u shaped profile and wherein the at least one engagement surface includes an inner surface (25a-25b) of the U-shaped profile, in particular an inner surface (25a, 25b) of one of the first and second legs (24a, 24b) of the U-shaped profile and/or an inner surface (25c) of the base (24c).

6. Elevator system (2) according to claim 1, wherein the at least one guide member (36, 38) is configured for moving along the first leg (24a) of the u shaped profile; and wherein the at least one safety gear (40) is configured for engaging with the second leg (24b) of the U-shaped profile;
wherein the at least one guide surface is formed on the first leg (24a), and wherein the at least one engagement surface is formed on the second leg (24b).

7. Elevator system (2) according to claim 6, wherein the at least one guide member (38) includes a U-shaped profile encompassing the first leg (24a), wherein the U-shaped profile of guide member (38) forms in particular a guide shoe encompassing the first leg (24a).

8. Elevator system (2) according to claim 6, wherein engagement surfaces are formed on an inner surface (25b) and on an outer surface (27b) of the second leg (24b), and wherein the at least one safety gear (40) is configured for engaging with the inner surface (25b) and with an outer surface (27b) of the second leg (24b).

9. Elevator system (2) according to claim 1, wherein the at least one guide member (36) includes at least one roller that is configured for rolling along the at least one guide surface.

10. Elevator system (2) according to claim 1, wherein the surface properties of the at least one guide surface and of the at least one engagement surface are identical, or wherein the at least one guide surface and the at least one engagement surface have different surface properties; wherein the at least one engagement surface has in particular a larger surface roughness than the at least one guide surface.

11. Elevator system (2) according to claim 1, wherein the elevator system (2) is a bufferless elevator system (2) that does not comprise any buffers at the bottom and/or at the top of the hoistway (4).

12. Elevator system (2) according to claim 1, wherein the first and second legs (24a, 24b) of the U-shaped profile are arranged in a distance of 80 mm to 100 mm from each other; and/or wherein the first and second legs (24a, 24b) extend over a length of between 50 mm and 75 mm from the base (24c).

13. Elevator system (2) according to claim 1, wherein the u shaped profile is formed by sheet-metal bending or by hot rolling.

14. Safety gear (40) configured for being arranged between the first and second legs (24a, 24b) of a guide rail (24) having a U-shaped profile, wherein the safety gear (40) comprises:
a first engagement member (42a) provided on a first side of the safety gear (40) and configured for engaging with a first engagement surface provided on the first leg (24a) of the u shaped profile when the safety gear (40) is activated;
a second engagement member (42b), in particular a roller, provided on an opposite second side of the safety gear (40) and configured for engaging with a second engagement surface provided on the second leg (24b) of the u shaped profile when the safety gear (40) is activated; and
at least one elastic element (44) that is configured for elastically urging the second engagement member (42b) against the second engagement surface when the safety gear (40) is activated.

15. Elevator system (2) comprising at least one safety gear (40) according to claim 14.
